(19) United States
(12) Patent Application Publication
(10) Pub. No.: US 2015/0052068 A1
(43) Pub. Date: Feb. 19, 2015

(54) Product For Unaudited Financial Statements And Method For Qualifying The Eligibility For Such A Product

(71) Applicant: Bruce George Wales, Mount Barker (AU)

(72) Inventor: Bruce George Wales, Mount Barker (AU)

(21) Appl. No.: 14/458,284

(22) Filed: Aug. 13, 2014

Related U.S. Application Data
(60) Provisional application No. 61/865,609, filed on Aug. 14, 2013.
(60) Provisional application No. 61/970,927, filed on Mar. 27, 2014.

(51) Int. Cl. G06Q 30/00

(52) U.S. Cl. CPC G06Q 30/018
USPC 705/317

(57) ABSTRACT

A system, product and method to increase the credibility of the unaudited financial statements of small and medium sized private enterprises combines such financial statements which satisfy eligibility criteria with an indemnity in favour of a named user of the unaudited financial statements for a loss which the user incurs as a consequence of those financial statements containing information that is materially incomplete or materially inaccurate. The financial statements are professionally compiled by a Certified Public Accountant in conjunction with that Accountant's completion of a related agreed-upon procedures engagement. The procedures are determined by the indemnity provider as being relevant and appropriate for the subject enterprise.

### FIELD OF THE INVENTION

The field of the invention is financial statements of Small and Medium enterprises and a means for providing a product including associated financial statements that will be acceptable to users of those financial statements and of benefit to the Small and Medium enterprises.

### BACKGROUND

When the size of a Small and Medium Enterprise's (SME) business is considered, and SME's cost to have its financial statements audited is an excessive burden in comparison to the cost of the audited financial statements considered in relation to statements for a larger non-SME business.

For example, a private company with gross revenue of $500 million might incur an audit fee of say $100,000. If audit fees were proportional to revenue, an SME with gross revenue of $50 million would incur an audit fee of $10,000 and an SME with gross revenue of $5 million would incur an audit fee of $1,000. Audit fees are not proportional to revenue and the latter two example SMEs can expect to incur audit fees of at least $30,000 and $25,000, respectively.

The disproportionate impact of audit fees on SMEs arises because audit standards, with which auditors must comply, apply to the financial statements of all enterprises regardless of their nature or size. The need to have their financial statement audited can impose an unwarranted cost-penalty on SMEs that are required to supply audited financial statements so that the intended users of those financial statements can be provided with a high level of assurance concerning said financial statements' completeness and accuracy.

All public companies are required by securities law to produce audited financial statements annually. However, many private SMEs also produce audited financial statements at the request or direction of stakeholders in those entities, such as bankers, who may be an intended user of the financial statements for tbe purpose of, for example, offering loans.

Independent, licensed, external CPAs provide audit, review, compilation, agreed-upon procedures and other financial statement services. Audit provides the highest level of assurance that can be provided to users of financial statements. Review provides only negative assurance and compilation provides no assurance. Financial statements prepared as a compilation engagement are unaudited and the preparing accountant provides users with no assurance concerning the content of such unaudited financial statements (UFS). An agreed-upon, procedures engagement provides only the CPA's findings horn the completion of each procedure and provides no assurance concerning the financial statements as a whole.

The expectation is that the content of unaudited financial statements, which are eligible for PUFS, will be the same as the content of an audited version of those same financial statements.

When preparing unaudited financial statements as a compilation engagement, CPAs do not regard their task as the preparation of a second class set of financial statements which may or may not be complete, accurate or misleading. On the contrary, they work diligently and apply their professional skills to produce financial statements with which tney are comfortable.

All CPAs, whether in public practice or employed in business, are obligated to follow the AICPA's Code of Professional Conduct when preparing financial statements. That Code requires a CPA to correct an entity's financial statements that are materially false or misleading or to completely disassociate himsel/herself from those financial statements.

The current usefulness to third parties of unaudited financial statements and accompanying compilation report is very limited and the expense of audited financial statements of an SME is disproportionally expensive based on the revenue of an SME compared to a non-SME, thus there is a need for a product that can be presented to a user of unaudited financial statements to increase the credibility of them, be acceptable to the user and at an expense to the SME that is more proportional to the revenue of the SME.

### BRIEF DESCRIPTION OF THE INVENTION

This surmnary of the invention is provided to introduce a selection of concepts in a simplified form that are further described below in the Detailed Description of Embodiments. This summary is not intended to identify key features or essential features of the claimed subject matter, nor is it intended to be used as an aid in the determining the scope of the classed subject matter.

In an aspect of the invention there is a method for qualifying the eligibility for a product which indemnifies to a predetermined monetary amount the intended user of the unaudited financial statements of a non-public enterprise having less than 500 employees or gross revenue of less than $50 million per annum, the method comprising the steps: a) receiving by the issuer of the product the type of industry in which the enterprise operates and the reporting framework on which its financial statements will be based; b) issuing by the issuer of the product two or more agreed-upon procedures predetermined according to the type of industry and reporting framework with the procedures to be performed by a CPA; c) receiving the unaudited financial statements, an accompanying compilation report, and a report on applying agreed-upon, procedures in conjunction with the preparation of the unaudited financial statements, all prepared by a CPA; d) qualifying the eligibility by: i) checking that the compilation report is unqualified; and ii) checking that there are no adverse findings of the agreed-upon procedures, wherein the product associated with the eligibility-qualified unaudited financial statements provides for the indemnity, to a predetermined monetary amount, to the intended user of those financial statements if the unaudited financial statements contain information that is materially incomplete or materially inaccurate; and e) issuing an indemnity which is referenced to and attached to a copy of the unaudited financial statements and accompanying compilation report.

In an aspect of the invention step c) of the method being the receiving of the report on applying agreed-upon procedures which include additional procedures and step d) includes the further step of; iii) determining the number of additional procedures and the related amount of discount of the monetary amount of a premium to be associated with the product.

In another broad aspect of the invention there is a product to indemnify to a predetermined monetary amount the intended user of the unaudited financial statements of a non-public enterprise having less than 500 employees or gross revenue of less than $50 million per annum; the product comprising: unaudited financial statements of the non-public enterprise prepared by a CPA; a compilation report prepared by the CPA and accompanying the unaudited financial statements; a report related to the unaudited financial statements on the application of two or more agreed-upon procedures by the CPA; and an indemnity to provide a predetermined monetary amount to the intended user of the unaudited financial statements if those unaudited financial statements include information that is materially incomplete or materially inaccurate.

In an aspect the product has a risk wherein the risk decreases for each additional agreed-upon procedure or additional procedures, all additional procedures performed by the CPA in conjunction with his/her preparation of the unaudited financial statements and compilation report.

In another aspect of the invention the product has a premium based on a predetermined monetary amount less the amount of discount according to a reduction in risk associated with the additional procedures.

The above briefly described Product for Unaudited Financial Statements (PUFS) concept requires the CPA preparing the unaudited financial statement to be aware of the findings of the related agree-upon procedures engagement before completing the preparation of those financial statements. Therefore, any findings of the agreed-upon procedures engagement which indicate incomplete or inaccurate information in the financial statement, must cause the CPA preparer to correct that financial statement.

In an agreed-upon procedures engagement the client or another specified party determines the subject matter of the procedures to be performed by the CPA. The detail of those procedures is mutually agreed-upon in writing between the CPA and a specified party.

Details concerning computers, computer networking, software programming, telecommunications and the like may at times not be specifically illustrated, as such were not considered necessary to obtain a complete understanding nor to limit a person skilled in the art in performing the invention, but are considered present nevertheless as such are considered to be within the skills of persons of ordinary skill in the art.

A detailed description of one or more preferred embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications, and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

Although the foregoing invention has been described in some detail for purposes of clarity of understanding, it will be apparent that certain changes and modifications may be practiced within the scope of the appended claims. It should be noted that there are many alternative ways of implementing both the process and apparatus of the present invention. Accordingly, the present embodiments are to be considered as illustrative and not restrictive, and the invention is not to be limited to the details given herein, but may be modified within the scope and equivalents of the appended claims.

Throughout this specification and the claims that follow unless the contest requires otherwise, the words ‘comprise’ and ‘include’ and variations such as ‘comprising’ and ‘including’ will be understood to imply the inclusion of a stated integer or group of integers bur not the exclusion of any other integer or group of integers.

The reference to any background or prior art in this specification is not, and should not be taken as, an acknowledgment or any form of suggestion that such background or prior art forms part of the common general knowledge.

The description may use the phrase “in an embodiment”, “in one or more embodiments”, which may refer to one or more of the same or different embodiments.

### BRIEF DESCRIPTION OF THE FIGURES

FIG. 1 depicts a flow diagram of the process of applying for a quotation for the product;

FIG. 2 depicts a flow diagram of the process of applying for the product;

FIG. 3 depicts a flow diagram of the process step of receiving the unaudited financial statements, a compilation report, and a report on applying agreed-upon procedures, all prepared by a CPA, and qualifying the eligibility for the product, and issue of the product;

FIG. 4 depicts a flow diagram of the update of the relevant agreed-upon procedures;

FIGS. 5 and 6 depict a table for each of two reporting frameworks illustrating the various variables and how they are applied when setting a premium rate for the product; and

FIG. 7 depicts a block diagram of processes involved in providing the product to a SME and the intended user of its unaudited financial statements.

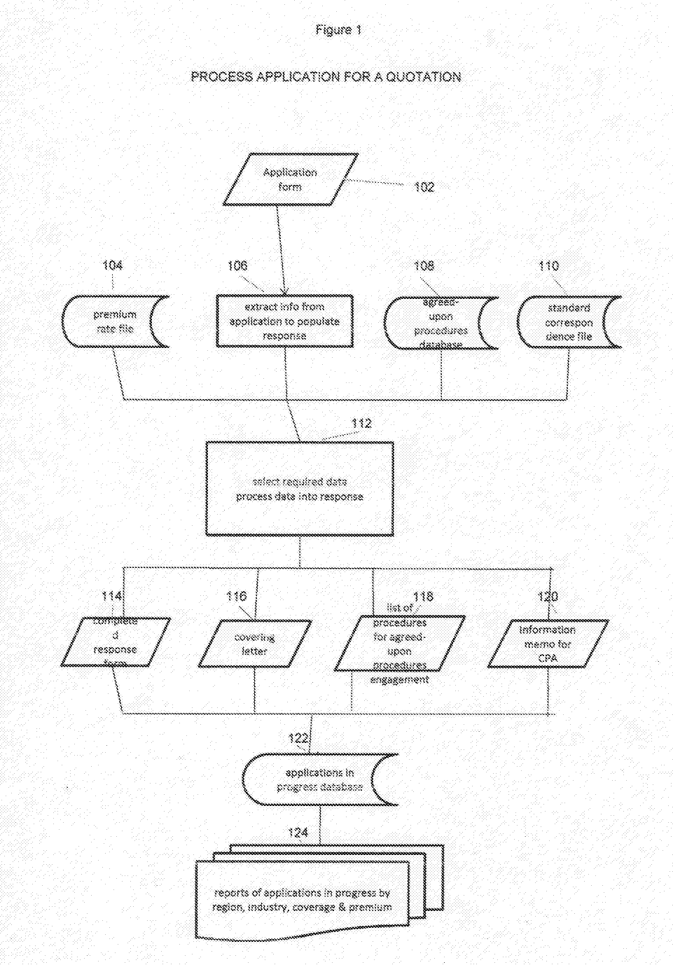

### DETAILED DESCRIPTION OF EMBODIMENTS OF THE INVENTION

The new product relates to professionally prepared unaudited financial statements of non-public SMEs. The Product for Unaudited Financial Statements (PUFS) is intended to indemnify the named intended user of the financial statements for a financial loss it incurs as a consequence of information included in the unaudited financial statements being materially incomplete or inaccurate.

The purpose of the product is to enhance the credibility of UFS's by providing the indemnity to the intended user of the UFS and thereby causing such financial statements to be an acceptable substitute for audited or reviewed financial statements. Parties likely or willing to accept the SME's product, including unaudited financial statements in lieu of its audited or reviewed financial statements, would include stakeholders in the SME such as a banker, another lender, a major creditor or a shareholder not involved in management.

Professionally prepared means prepared by an independent licensed Certified Public Accountant (CPA) pursuant to the technical and ethical standards of the American Institute of Certified Public Accountants (AICPA) (referred to herein as “Standards”) for non-audit engagements. The nature and minimum scope of the work to be carried out by the CPA in preparing unaudited financial statements is to be based on a ‘risk selection system’ comprised of examination procedures and used by the Issuer to qualify the unaudited financial statements of an individual SME. In this specification the term issuer is to be broadly interpreted and thereby to include but not be limited to, an insurer issuing an insurance product, and an entity providing the indemnity. The procedures which apply to each SME will be specified in the terms of an agreed-upon procedures engagement. Many, if not most, of those procedures would routinely be carried out by the CPA in the ordinary course of he/she preparing the unaudited financial statements as a compilation engagement. The extent of the CPA's work under the combined compilation and agreed-upon procedures engagements is expected to be less than one half that ordinarily required to complete an audit of the same financial statements. Hence, the cost of professionally prepared unaudited financial statements, which are eligible for the product, is expected to be less than one half the cost of an audit of that same SME. In addition to the professional fees charged by the CPA, the SME will be responsible for paying the cost of the product.

Purchasing PUFS may appeal primarily to those SMEs or other entities, which can experience a significant cost saving by switching from an Audit or a Review of their financial statements to a compilation. The intended users of their financial statements would, of course, have to be willing to accept such a product including unaudited financial statements, in lieu of their historic requirement of audited financial statements. A substantial cost saving to the SME may be the main factor motivating both the SME and its stakeholder to accept this new product for the provision of credible unaudited financial statements.

Thus in an embodiment the product for use by a stakeholder-user to reduce the risk associated with the unaudited financial statements of an entity, is a product comprising the unaudited financial statements and accompanying compilation report, together with an associated insurance which provides an indemnity that addresses the material completeness and material accuracy of the unaudited financial statement and the existence of a related report on performing or applying agreed-upon procedures which influence the cost of the insurance product and allows the insurer to qualify the eligibility of the UFSs for the product.

Qualifying criteria for PUFS eligibility may include only compilation financial statements of non-public SMEs which are prepared in accordance with the reporting frameworks of Generally Accepted Accounting Principles for Private Companies (GAAP) or Financial Reporting Framework for SMEs (FRF for SMEs), are eligible.

For the purpose of the product, non-public SME means that.
Its equity or debt instruments are not listed for public trade; or
Its business does not include the holding, to a fiduciary capacity, of assets owned by third parties

Size limitations of qualifying SMEs are gross revenue not exceeding $50 million per annum or total fulltime equivalent employees not exceeding 500.

Unaudited financial statements bearing a CPA's ‘clean’ compilation report and having been the subject of an agreed-upon procedures engagement which resulted in a CPA's ‘clean’ report on applying agreed-upon procedures are a requirement. A ‘clean’ compilation report is one that does not contain any qualifications and a ‘clean’ report on applying agreed-upon procedures is one that does not contain an adverse finding which may indicate the possible existence of incomplete or inaccurate information in the unaudited financial statements. An unqualified compilation report and a report on applying agreed-upon procedures without adverse findings are fundamental in assessing unaudited financial statements as eligible for PUFS.

The CPA's compilation report is to be dated no earlier than the date of the related report on applying agreed-upon procedures.

The procedures specified for an agreed-upon procedures engagement shall be the minimum procedures predetermined by the Insurer as appropriate for an enterprise operating in the applicant's industry and having its financial statements prepared in accordance with its chosen reporting framework, being either GAAP or FRF for SMEs.

Unaudited financial statements bearing compilation or agreed-upon procedures reports of professional accountants other than CPAs may be accepted for PUFS provided those accountants are licensed to practice public accounting and are members of a professional association obligating them to the same technical and ethical standards as apply to CPAs.

Agreed-Upon Procedures Database

The primary determinant of whether or not a SME's unaudited financial statements are eligible for the product is the CPA's findings from his/her completion of the procedures contained in the agreed-upon procedures database, which are applicable to enterprises in the same industry as the applicant SME and using the same financial reporting framework as the applicant SME.

The applicable procedures for each applicant's financial statements are selected from the database using the Issuer/Insurer's proprietary software. The detaled description of each selected procedure is used to populate the procedure section of the agreed-upon procedures engagement contract between the CPA and its client, with the Insurer being named a specified party for the purpose of agreeing the procedures with the CPA.

The Issuer/Insurer manages the risk level of insured unaudited financial statements by increasing or decreasing the number and/or scope of procedures applicable to individual financial statements in the agreed-upon procedures database. Increased procedures result in decreased risk and decreased procedures result in increased risk. In that way the database serves as a “risk selection system” and enables the Insurer to adjust its level of risk in response to its claims experience.

Creation of Initial Agreed-Upon Procedures Database

CPAs experienced in assurance services and the preparation of unaudited financial statements as the product of compilation engagements will be engaged to specify the minimum procedures to be carried out for each potential line item in an SME's financial statements when operating in a common industry such as Retail Trade and having its financial statements prepared in accordance with a specific financial reporting framework, such as GAAP, allowed by the Standards for general purpose financial statements of non-public SMEs. Each of these procedures will be identified as “universal” or “industry specific”. Additional “industry specific” procedures will be included that are uniquely appropriate for SMEs in each other industry sector included in the North American industry Classification System in (NAICS) code.

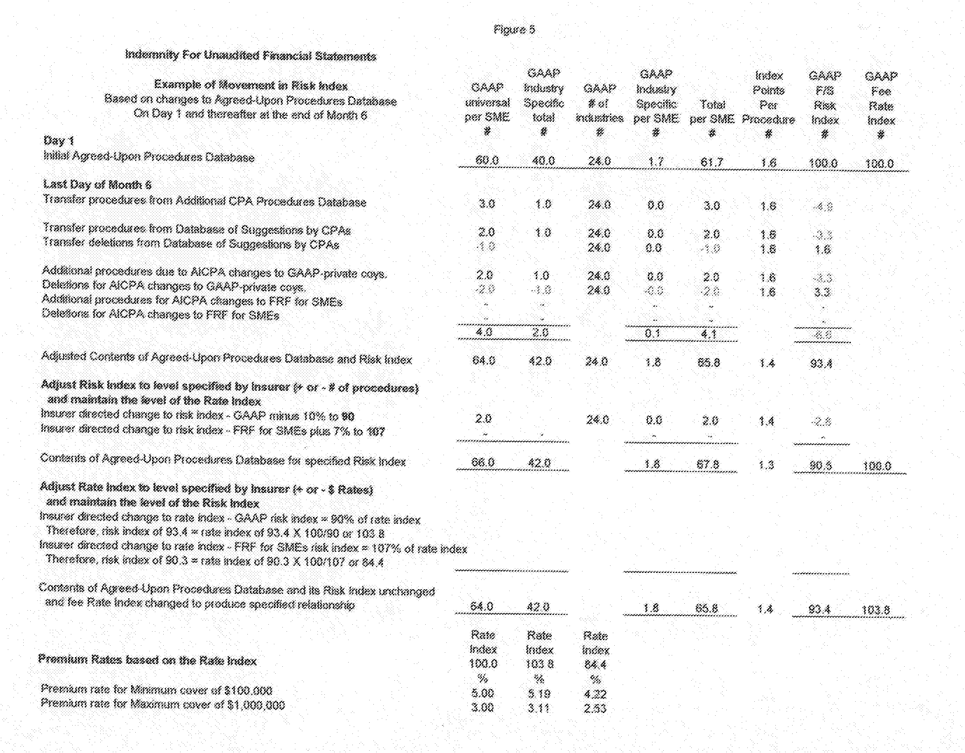

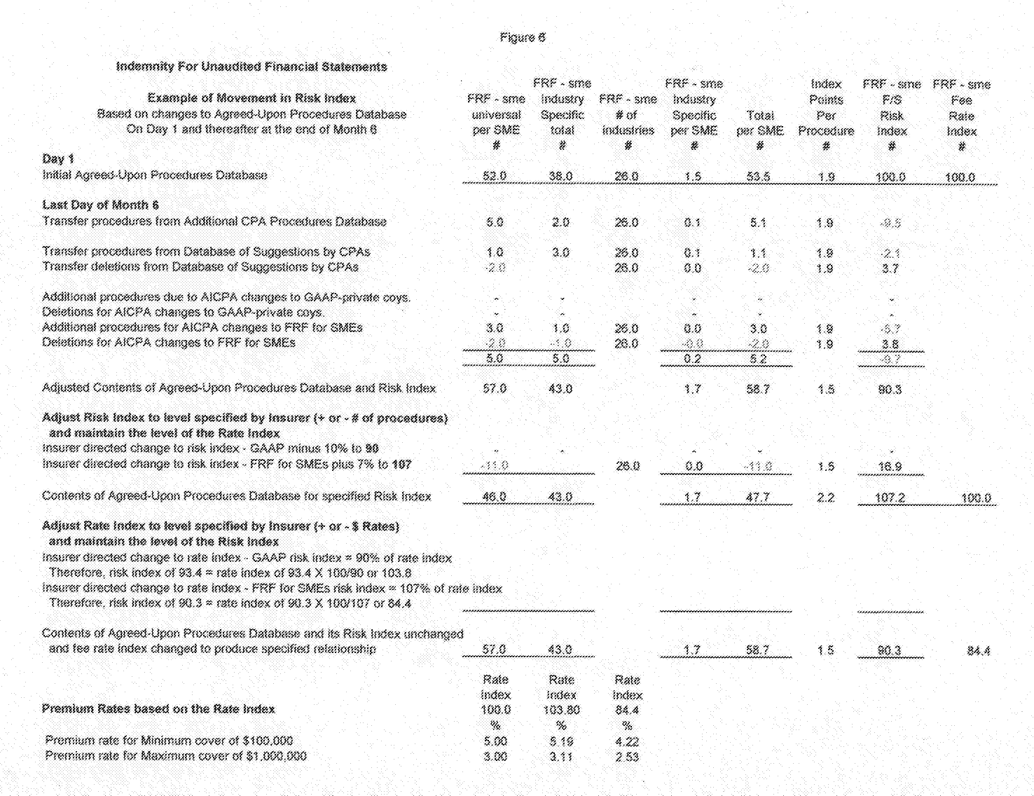

The whole of those GAAP procedures will be replicated and each procedure identified as also applicable for financial statements prepared according to FRF for SMEs or, if not, deleted and replaced by a new procedure for that financial statement line item which is applicable for financial statements prepared according to FRF for SMEs. The number of universal procedures and the average number of industry specific procedures in the initial database may be used to determine an initial Risk Index as illustrated in FIGS. 5 and 6.

The objective of the authors of the initial database will be to produce a collection of efficient and effective procedures for use in professionally producing compilation financial statements having a high probability of being materially complete and materially accurate.

Steps Followed by CPA Firm for Outsourced Creation of Initial Agreed-Upon Procedures Database

For each of say 20 or so completed compilation engagements, obtain from working paper files:
For each client, record its industry type as a NAICS code, reporting foremat, gross revenue and employee numbers;
List the procedures carried out concerning each line item of unaudited financial statements including notes;
Mark each procedure as being “universal” or “industry specific”
List potential extra procedures which might be considered
For procedures actually carried out, record staff time by category and total fee
Estimate staff time by category and fee, as if audit instead of compilation

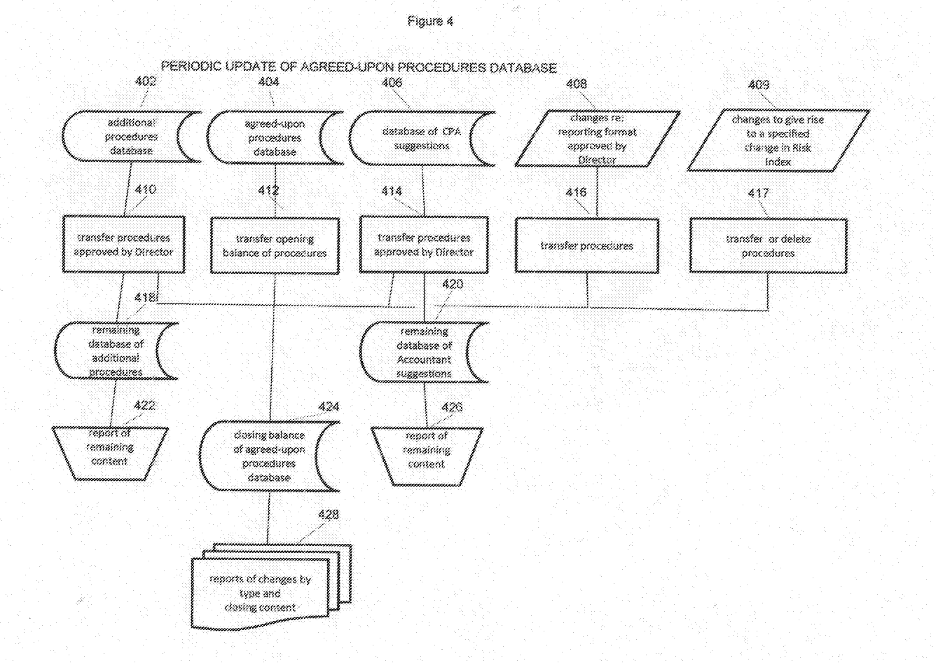

Input to Agreed-Upon Procedures Database and Source of that Input
Initial database of procedures created by CPA firm as outsourcers
Changes to the initial database may occur periodically as illustrated in FIG. 4 and as described below.
Director approved transfers from Additional Procedures Database—reduces Risk Index
Director approved transfer of procedures from Database of Suggestions by Panel Accountants—reduces Risk Index:
Director approved transfer of deletion of a procedure from Database of Suggestions by Panel Accountants—increases Risk Index
Director approved changes, + or −, due to changes to reporting framework within the Standards

Periodic Change in Relationship Between Risk and Insurance Premium Rates

From time to time the Insurer will instigate a change in the level of risk it is prepared to accept in comparison to the amount of insurance premium it charges for its indemnity. The change may be in response to its claims experience and/or market forces and can be accomplished by increasing or decreasing the number of procedures contained in the agreed-upon procedures database and leaving its insurance premium rates unchanged. That process changes the Risk Index whilst premium rates, as reflected by the Rate Index, would remain constant as a percentage of the predetermined monetary amounts of limit provided.

Alternatively, the Insurer can choose to leave the procedures within the agreed-upon procedures database unchanged and instead change the relationship between risk and rates by making an appropriate increase or decrease to the Rate Index and thereby change the insurance premium rates. The Rate Index would be changed whilst the Risk Index remains constant.

FIGS. 5 and 6 illustrate for each of two reporting frameworks the two alternative ways of changing the relationship between risk and revenue by either changing the Risk Index, by increasing or decreasing the procedures to be carried out, or changing the Rate Index which defines the revenue for the amounts of indemnity limit to be provided.

The first of the two alternatives would be accomplished by processing Director approved changes in response to Insurer's Direction to increase or decrease the Risk Index by a specified percent either universally or by industry.

It may be commercially desirable to change both the Rate Index and the Rate Index to the extent necessary so that the net change in the relationship between the two is equal to the change in risk specified by the Insurer.

Addional Procedures to Insurer's Specified Agreed-Upon Procedures

At their discretion and as part of their compilation engagement, CPAs may carry out additional procedures which they deem appropriate. The CPA will list the additional procedures and their findings as an addendum to their report on applying agreed-upon procedures. The fact that the CPA performed extra procedures may give rise to a reduction in the quoted insurance premium amount. If the premium calculation is allowed to be variable based on the actual scope of the procedures carried out by the CPA in compiling the financial statements, the more procedures the CPA performs, the lower the final insurance premium. Additional procedures which constitute bookkeeping would not qualify for a discount to the insurance premium amount.

The standard quoted premium amount for a given amount of indemnity limit may be reduced by a discount of 1% or so for each additional procedure which the CPA deemed appropriate and carried out of his/her own volition.

Giving the discount illustrates the Insurer's reliance on the agreed-upon procedures database as a “risk selection system” because if the additional procedure had been included in the agreed-upon procedures engagement, a reduced insurance premium would have been warranted because of reduced risk.

Application For a Quotation Received by the Issuer

An application for an insurance premium quotation 102 requires the applicant to specify the nature of the SME's business by its related NAICS code, the reporting framework used to produce its financial statements and the amount of the indemnity limit it wishes to purchase 106. From this information, the Insurer or its appointed services provider, will use its proprietary software to select from the agreed-upon procedures database 108 a complete listing of the minimum procedures 118 it will require to be the subject of an agreed-upon procedures engagement contract between the SME and its external CPA. The Insurer's issuing of the listing of the minimum procedures for the specific enterprise enables the CPA to quote his/her professional fee to the SME for both the compilation and agreed-upon procedures engagements. For any enterprise the minimum number of agreed-upon procedures shall be two or more.

Other Aspects of the Product

### Documentation of Indemnity

Provision of the indemnity may be documented as a new type of insurance cover, an Agreement of Indemnity, a guarantee, a performance bond or another contractual means by which a named beneficiary can be indemnified for a loss incurred in specific circumstances. In this specification, the Insurer is the issuer of an insurance policy to document the provision of the indemnity which is embodied within the product.

Nexus Between Loss Incurred by the Named Intended User and Deficient Information

The nexus between a loss incurred by the named insured and inaccurate and/or incomplete information in the financial statements of a SME is that the nature and/or amount of any such deficiency is of sufficient magnitude or materiality that if it had been accurately and completely stated in the financial statements, such accurate and complete information would have caused any reasonable person to not have formed or maintained the same stakeholder relationship with said SME as the relationship which existed between said SME and the named insured at the time it incurred the loss, thereby enabling that party, the intended user, to have avoided or reduced its financial loss.

Maximum Amount of Claim

The maximum amount of any payout will be the lesser of the amount of the financial loss incurred by the named assured or the predetermined monetary amount of the limit. The named insured must have done all things possible to mitigate the amount of its loss. The claim will not apply if the deficiency in the financial statements has been caused by fraud on the part of the SME's directors, officers, employees, contractors, agents, advisers or other stakeholders.

Adjudication of Claim

Adjudication of a claim would firstly involve the verification of the claimed facts:
The subject financial statements did contain information which was materially incomplete or inaccurate;
That deficiency was not caused by fraud;
The insured did incur a financial loss of $x; and
The Insured took reasonable steps to mitigate its loss.

If the findings concerning the above are all true, the Adjudicator would consider whether it is plausible that, given the deficient information had been completely and accurately disclosed in the financial statements, the Insured would have or could have taken steps to avoid or minimise its loss. If the decision was that avoidance of the loss was plausible, then the claim would be paid. If the decision was that minimization of the loss was plausible, then the claimant would be offered the lesser of the indemnity limit or the potential reduction in the loss. Alternatively, a negotiated settlement or a court ordered outcome might eventuate.

Referral of Non-Compliant Financial Statements

If the unaudited financial statements do not include a ‘clean’ compilation report or a ‘clean’ report on applying agreed-upon procedures, they will be classified as non-compliant and referred to the Non-Compliance Committee of the Insurer for its decision to provide the cover at a penalty rated insurance premium or to deny its provision. The Committee may be chaired by an experienced CPA and the Committee's decision may be baaed upon the Insurer's schedule of potential deficiencies classified by their nature and amount and their acceptability rating.

Pricing of the Product

Indicative initial range of the product limits and premium rates:

| | |
|---|---|
| minimum predetermined monetary amount of limit-$100,000 | 5% |
| maximum predetermined monetary amount of limit-$1,000,000 | 3% |

Replication of Business Model for Use in Other Countries

Amend proprietary database of agreed-upon procedures for locally prescribed financial reporting frameworks.

Sharing the Benefits of PUFS
SMEs—may receive credible financial statements, which cost less than one half the cost of audited financial statements.
Insurer—a new product to produce extra profit.
Banks and other Stakeholders in SMEs—receive assurance concerning financial statements in the form of an insurance product which would reduce the amount of a qualifying loss incurred by a named bank or another stakeholder. May enable banks to lower their lending risk and thereby lower related statutory reserve.
CPA—He/she may have a new assurance product to offer to existing growth clients and the intended users of their financial statements.

### Commercialization of the Product

There are a number of routes to commercialization of the product. An exemplary route is described below. Other routes may also be suitable. Specifically, the magnitudes of the parameters described below may be adjusted to suit different requirements for commercial success.

License an Appropriate Enterprise to Act as the Patentee's Licensee

The basic terms of the license would include:
Exclusive right to provide the product within Australia for a certain number of years provided a mutually agreed schedule of revenue performance is achieved. Failure to reach revenue goals may result in loss of exclusivity, not necessarily loss of license;
The licensee agrees to not compete with the business of PUFS during the period of the license plus two years thereafter (or other term);
License Fee equal to x% of PUFS gross revenue payable quarterly in arrears (or on another mutually acceptable schedule or basis);
Licensee agrees to advertise and promote the product and offer it for sale through its distribution channels;
The licensee accepts the content of the initial agreed-upon procedures database. That content may only be changed by mutual agreement of patentee and licensee.

Proposed Structure of Business in USA

### Two Divisions

A Services Division located at one central location administers compliance process by PUFS applicants and grants approval of qualifying financial statements. A Professional Support Division operates from several locations throughout the US.

Services Division

Perform the compliance and approval processes described above as well as maintenance of web site and general data processing services.

Professional Support Division

Serving as liaison amongst SME clients, CPAs, SME stakeholders and the Services Division;

Promoting the product to the same parties and monitoring the smooth flow of the compliance process; and

Provide administration and technical assistance to Panel Accountants.

Panel of Accountants
CPAs who are registered assurance practitioners may be eligible for membership in the Insurer's Panel of Accountants supporting the product for SMEs;
Panel Member Accountants may advertise that unaudited financial statements compiled by them can be insured as being materially complete and accurate;
The issuer for SMEs may refer inquiries from SMEs or their stakeholders to Panel Members located near the SME;
For each engagement for unaudited financial statements the Panel Member may provide time/fee data by staff category and may procide an estimate of what an audit would have cost;
Panel Members may make suggestions to improve the efficiency or effectiveness of procedures included in the agreed-upon procedures database; and
For each engagement that is expected to lead to financial statements eligible for the product, the Panel Member may provide a letter of understanding to acknowledge.
   the definition of SMEs for which the issuer is willing to consider the provision of the product and stating that the client complies; and
   that the insured risk is the completeness and accuracy of the unaudited financial statements.

Computerized Data Processing Services to Enable or Support the Issue of the Product

Insurer's Databasee of Applications in Progress 122
Maintained to illustrate changing status of each application received and to initiate follow-up actions by the Insurer or its appointed services provider; and
Contains digital copy of all forms and correspondence from and to applicant.

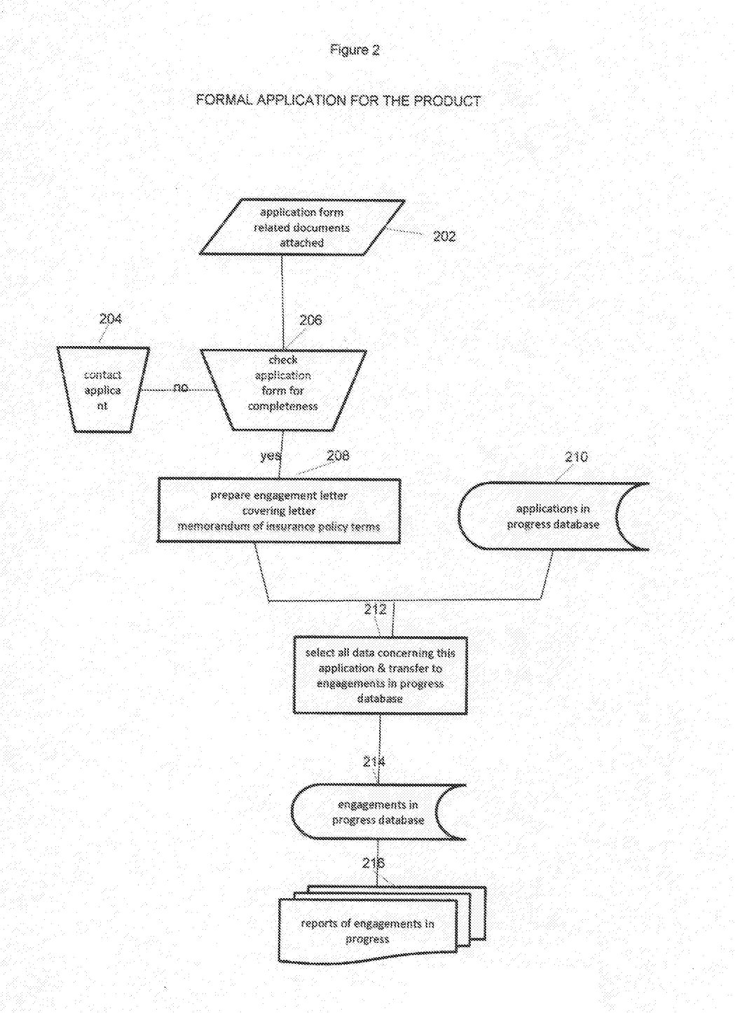

Application Form for the Product Received by Issuer 202
Sourced from the issuer's or its service provider's web site;
Completed by SME, its external CPA, its insurance broker, and insurance agent or other intermediary;
Provides information regarding the SME, its business and NAICS code;
CPA's details;
Intended user's details and its relationship to SME;
Predetermined monetary amount of the indemnity limit requested; and
Identity of sales person and their contact details.
The information provided is checked manually or electronically for completeness and compliance with eligibility criteria 206 as referred to in FIG. 2.

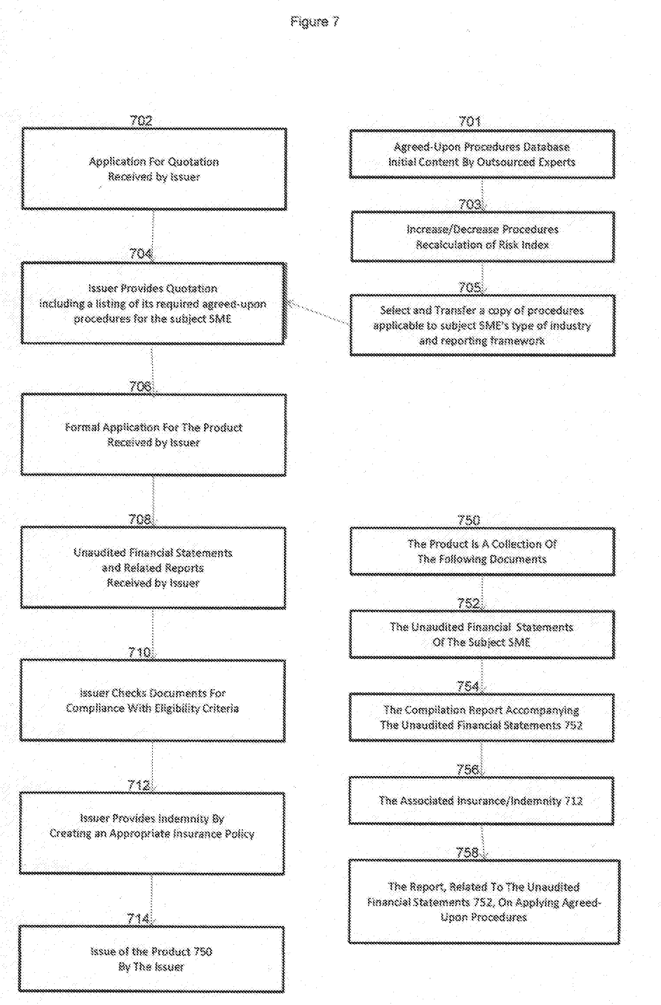

Insurer's Response to Application, Providing the Following
Prepare agreed-upon procedures engagement letter between the Insurer, the SME and its external CPA containing a schedule of minimum agreed-upon procedures which are applicable to the SME 208. The engagement letter also obligates the CPA to include the particulars of any additional procedures and related findings as an addendum to the report on applying the agreed-upon procedures;
The covering letter may obligate the SME to pay a deposit of x% of insurance premium on signing. The deposit is to be credited on Insurer's invoice for premium or refunded if the issuer ultimately refuses to provide its cover;
The insurance premium is quoted for the amount of indemnity limit requested and a plain English description of insurance policy terms is provided;
Entry is made to the database of engagements in progress 214; and
The computerized processing of the above application and the issuer's response are illustrated in FIG. 2 and FIG. 7.

Transmittal Cover Sheet/Checklist from CPA to Issuer 302
CPA details
SME details
Unaudited FS for year ended ______
Page 1 ______
Page 2 ______
Etc
CPA's Reports ______ Compilation ______ qualified?
______ Agreed-Upon Procedures ______ qualified
______ adverse finding?
Additional procedures performed ______ yes ______ no

Remainder of This Form, as Below, Is Completed as the Issuer's Document Receiving Report

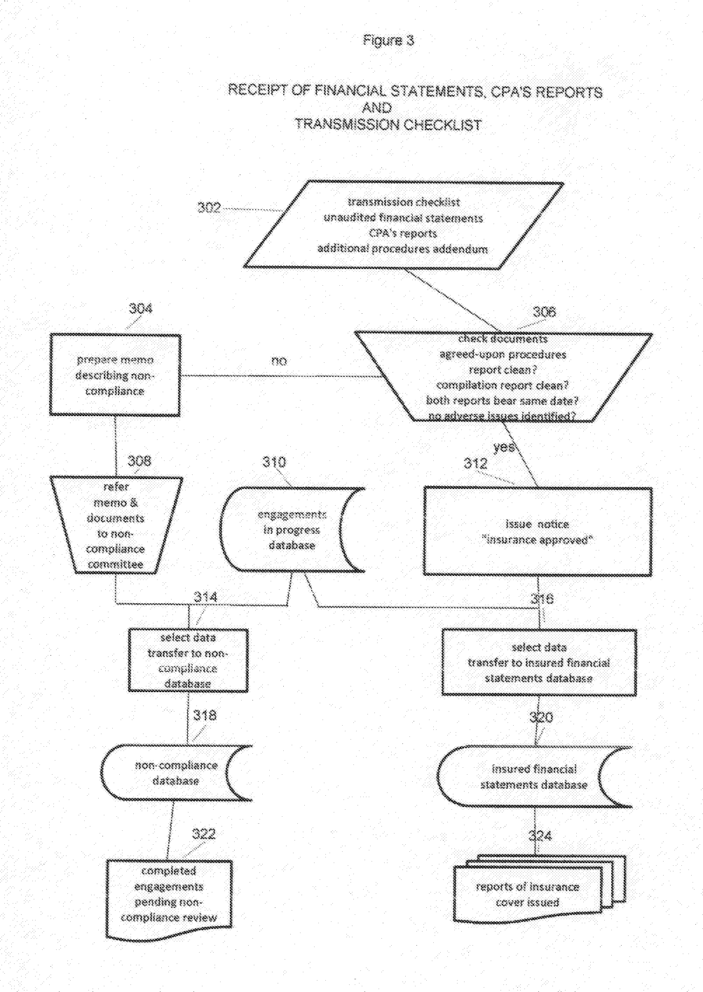

The above Transmittal Cover Sheet/Checklist and the accompanying documents are scrutinized by a member of the issuer's staff as a checking procedure to ensure that the compilation report is without qualification and that the report on applying agreed-upon procedures does not include any adverse findings 306. Alternatively a machine readable form and a computer program and device to read the form could be used to perform the act of checking the eligibility for the product by checking that associated and specific areas of the form are annotated in a manner indicting that there are no qualifications or adverse findings.
Documents rendered and printed ______
Unaudited Financial Statements ______
CPA's Reports ______ Compilation ______ Date
______ Agreed-Upon procedures ______ Date
Described Qualifications or Adverse Findings.
______
______
Documents checked by ______
Application for the product approved 312 ______
Application referred to Non-compliance committee 304 ______
Details recorded in engagements in progress database 310 and insured financial statements database 320.
The foregoing is illustred in FIG. 3.

Periodic Reports 324
Applications in Progress;
Engagements in Progress;
Insurance cover issued; and
Database of financial statements for which the product is issued
   NOTE: All of above communicating processes are electronic and computerized using software written by one of skill in the art, readily possible by working to the requirements disclosed in detail in this document.

Periodic Reports of Content in Agreed-Upon Procedures Database
An analysis of content for each of GAAP and FRF for SMEs reporting frameworks as at a specific point in time such as a month end 428 as feferred to in FIG. 4:
   Universal procedures by financial statement line item;
   Number of universal procedures by financial statement line item and their grand total number;
   Industry specific procedures by industry by financial statement line item and their grand total number;
   Industry specific procedures by industry by financial statement line item; and
   Number of industry specific procedures by financial statement line item, the grand total number of procedures and industries and the average number per industry.
an analysis of additions and deletions to content for a specific period of time such as a month:
   Director approved transfers from additional procedures database 410;
   Director approved transfers of additional procedure from Database of Suggestions by Panel Accountants 414;
   Director approved transfer of deletion of a procedure from Database of Suggestions by Panel Accountants 414;
   Director approved changes, + or −, due to AICPA prescribed changes to a reporting framework 416; and
   Director approved changes in response to issuers Direction to increase or decrease the Risk Index 417 by a specified percent either universally, by industry or by reporting framework.

Input to Additional Procedures Database and Source of that Input
Each additional procedure (excepting bookkeeping services) may be recorded by CPA on electronic copy of addendum to their report on applying agreed-upon procedures. Each reported additional procedure would include a reference to the financial statment line item, financial statement reporting framework, SME's industry code and its classification as either universal or industry-specific; and
Director approved transfers from additional procedures database to agreed-upon procedures database 410.

Periodic Reports of Content in Additional Procedures Database 422
For change during month and month-end content:
   Universal procedures by financial statement line item;
   Number of universal procedures by financial statement line item and their grand total number;
   Industry specific procedures by industry by financial statement line item; and
   Number of industry specific procedures by financial statement line item, the grand total number of procedures and industries and average number per industry.

Input to Database of Suggestions by Panel Accountants and Source of the Input
Electronic form may be found on Issuer's web site and duly completed by Panel Accountant.

Periodic Reports of Database of Suggestions by Panel Accountants
For each of GAAP and FRF for SMEs reporting frameworks, for change during month and month end content 426:
   Universal procedures by financial statement line item;
   Number of universal procedures by financial statement line item and their grand total number;
   Industry specific procedures by industry by financial statement line item; and
   Number of industry specific procedures by financial statement line item, the grand total number of procedures and industries and the average number per industry.

The processes depicted in FIG. 7 and 702 and 706 may be effected by a computer device and associated database used by the SME or its CPA to communicate and interact with the issuer of the product, which can by way of example, be achieved using a web page interface to the issuer's database and processor and yet a further method of communication and interaction is by way of electronic forms made available by the issuer. The act of making a form or any other file can be by sending a copy of the form in a suitable format, by way of allowing access to download a copy of the file, or by way of access to the forms so that they can be sent to a web browser for download or replication in the browser window from which the user of the browser can download a copy, fill out the form, and then send the relevant filled out back to the server providing those forms, and many other ways known to those of skill in the art, the mentioned ways being embodiments that are known to be effective in the particular environment of the performance on embodiments of the invention.

Other processes depicted in FIG. 7 at 704, 708, 710, 712 and 714 may be provided by the issuer's system in a basic form and comprises a server and associated database. The database can by way of example include lists of agreed-upon procedures each being associated with a particular type of industry or work place of SMEs Further the database and processor of the server can be used to qualify the eligibility of the unaudited financial statements and accompanying compilation report to create the product, which can then be made available to the user. The product carries with it an indemnity to a predetermined monetary amount to the benefit of the intended user of the unaudited financial statements of a non-public enterprise having less than 500 employees or gross revenue of less than $50 million per annum.

The product is not just an indemnity, it is a separate entity representing a collection of individual elements which together represent something that a user can accept as increasing the credibility of the unaudited financial statements by knowing that relevant and appropriate agreed-upon procedures for the particular SME, as determined by the indemnity provider, have been followed.

Further once the eligibility is established, the product as described and defined herein may be electronically produced and transmitted to the SME and to the intended user of its unaudited financial statements. FIG. 7 also depicts the product 750 being issued by the issuer as the collection of the unaudited financial statements of the subject SME 752, the compilation report 754 accompanying the unaudited financial statements 752 together with an associated insurance/indemnity 756 that addresses the material completeness and material accuracy of the unaudited financial statements and the existence of a related report on applying agreed-upon procedures 758.

1. A method for qualifying the eligibility for a product which indemnifies to a predetermined monetary amount the intended user of the unaudited financial statements of a non-public enterprise having less than 500 employees or gross revenue of less than $50 million per annum, the method comprising the steps:
a) receiving by the issuer of the product the type or industry in which the enterprise operates and the reporting framework on which its financial statements are based;
b) issuing by the issuer of the product two or more agreed-upon procedures predetermined according to the type of industry and reporting framework with the procedures to be performed by a CPA;
c) receiving the unaudited financial statements; an accompanying compilation report, and a report on applying agreed-upon procedures in conjunction with the preparation of the unaudited financial statements, all prepared by a CPA, and
d) qualifying the eligibility by:
i) checking that the compilation report is unqualified; and
ii) checking that there are no adverse findings of the agreed-upon procedures, wherein the product associated with the eligibility-qualified unaudited financial statements provides for the indemnity, to a predetermined monetary amount, to the intended user of those financial statements if the unaudited financial statements contain information that is materially incomplete or materially inaccurate; and
e) issuing an indemnity which is referenced to and attached to a copy of the unaudited financial statements and accompanying compilation report.

2. The method according to claim 1, wherein step c) the received report on applying agreed-upon procedures includes an addendum describing additional procedures and step d) includes the further step of:
iii) determining the number of additional procedures and the related amount of discount of the monetary amount of the premium to be associated with the product.

3. A product to indemnify to a predetermined monetary amount the intended user of the unaudited financial statements of a non-public enterprise having less than 500 employees or gross revenue of less than $50 million per annum; the product comprising:
a) unaudited financial statements of the non-public enterprise prepared by a CPA;
b) a compilation report prepared by the CPA and accompanying the unaudited financial statements;
c) a report related to the unaudited financial statements on the application of two or msm agreed-upon procedures by the CPA;
d) an indemnity to provide a predetermined monetary amount to the intended user of the unaudited financial statements if those unaudited financial statements include information that is materially incomplete or materially inaccurate.

4. The product according to claim 3 having a risk wherein the risk decreases for each additional agreed-upon procedure or additional procedure, all additional procedures performed by the CPA in conjunction with he/she preparing the unaudited financial statements and compilation report.

5. The product according to claim 4 having a premium amount based on the predetermined monetary amount less the amount of discount according to a reduction in risk associated with the additional procedures.
